(19) United States
(12) Patent Application Publication
(10) Pub. No.: US 2026/0072460 A1
(43) Pub. Date: Mar. 12, 2026

(54) REVERSE CURRENT PROTECTION IN LINEAR VOLTAGE REGULATORS

(71) Applicant: Texas Instruments Incorporated, Dallas, TX (US)

(72) Inventors: Venkateswarlu Ramaswamy Tiruvamattur, Bengaluru (IN); Sudharsan Sundararaj, La Jolla, CA (US); Varun Upadhyaya, Bengaluru (IN)

(21) Appl. No.: 19/224,232

(22) Filed: May 30, 2025

(30) Foreign Application Priority Data
Sep. 11, 2024 (IN) 202441068872

(51) Int. Cl. G05F 1/565

(52) U.S. Cl. CPC G05F 1/565

(57) ABSTRACT

An example apparatus includes a first transistor having a control terminal and first and second terminals. The apparatus includes a second transistor having a control terminal and first and second terminals, the second terminal of the second transistor coupled to the second terminal of the first transistor. The apparatus includes a first amplifier having a first input, a reference input, and an output, the first input of the first amplifier coupled to the first terminal of the first transistor, the output of the first amplifier coupled to the control terminal of the first transistor. The apparatus includes a second amplifier having first and second inputs and an output, the first input of the second amplifier coupled to the first terminal of the first transistor, the second input of the second amplifier coupled to the first terminal of the second transistor, and the output of the second amplifier coupled to the control terminal of the second transistor. The apparatus includes a control circuit coupled to the control terminal and the second terminal of the second transistor and coupled to the first transistor, the control circuit capable of adjusting a voltage at the control terminal of the second transistor responsive to a current through the first transistor.

### CROSS-REFERENCE TO RELATED APPLICATION

This patent application claims the benefit of and priority to Indian Provisional Patent Application No. 202441068872 filed Sep. 11, 2024, which is hereby incorporated herein by reference in its entirety.

### TECHNICAL FIELD

This description relates generally to voltage regulators and, more particularly, to reverse current protection in linear voltage regulators.

### BACKGROUND

Linear voltage regulators, also referred to as linear regulators, are essential components in electronic systems, providing a stable and precise output voltage by continuously adjusting the resistance of a pass element to match load conditions. Linear regulators offer a clean, low-noise power supply, which renders them particularly valuable in sensitive applications such as analog circuits, audio equipment, communication devices, and instrumentation. The design of linear regulators allows for easy integration into a wide variety of systems. Linear regulators are widely used in consumer electronics, medical devices, and embedded systems where reliability, minimal output voltage ripple, and fast response to changes in load are relevant considerations.

### SUMMARY

For reverse current protection in linear voltage regulators, an example apparatus includes a first transistor having a control terminal and first and second terminals. The apparatus includes a second transistor having a control terminal and first and second terminals, the second terminal of the second transistor coupled to the second terminal of the first transistor. The apparatus includes a first amplifier having a first input, a reference input, and an output, the first input of the first amplifier coupled to the first terminal of the first transistor, the output of the first amplifier coupled to the control terminal of the first transistor. The apparatus includes a second amplifier having first and second inputs and an output, the first input of the second amplifier coupled to the first terminal of the first transistor, the second input of the second amplifier coupled to the first terminal of the second transistor, and the output of the second amplifier coupled to the control terminal of the second transistor. The apparatus includes a control circuit coupled to the control terminal and the second terminal of the second transistor and coupled to the first transistor, the control circuit capable of adjusting a voltage at the control terminal of the second transistor responsive to a current through the first transistor. Other examples are described.

For reverse current protection in linear voltage regulators, an example apparatus includes a first transistor having a control terminal and first and second terminals. The apparatus includes a second transistor having a control terminal and first and second terminals, the second terminal of the second transistor coupled to the second terminal of the first transistor. The apparatus includes a first amplifier having a supply terminal, a first input, a reference input, and an output, the first input of the first amplifier coupled to the first terminal of the first transistor, the output of the first amplifier coupled to the control terminal of the first transistor. The apparatus includes a second amplifier having first and second inputs and an output, the first input of the second amplifier coupled to the first terminal of the first transistor, the second input of the second amplifier coupled to the first terminal of the second transistor, and the output of the second amplifier coupled to the control terminal of the second transistor. The apparatus includes a third transistor having a control terminal and first and second terminals, the first terminal of the third transistor coupled to the first terminal of the second transistor, the second terminal of the third transistor coupled to the supply terminal of the first amplifier, and the control terminal of the third transistor coupled to the output of the second amplifier. Other examples are described.

For reverse current protection in linear voltage regulators, an example system includes a low-dropout (LDO) regulator having an input voltage terminal, a reference terminal, and an output voltage terminal, the LDO regulator including: a first transistor having a control terminal and first and second terminals; a second transistor having a control terminal and first and second terminals, the second terminal of the second transistor coupled to the second terminal of the first transistor; a first amplifier having a supply terminal, a first input, a reference input, and an output, the first input of the first amplifier coupled to the first terminal of the first transistor, the output of the first amplifier coupled to the control terminal of the first transistor; a second amplifier having first and second inputs and an output, the first input of the second amplifier coupled to the first terminal of the first transistor, the second input of the second amplifier coupled to the first terminal of the second transistor, the output of the second amplifier coupled to the control terminal of the second transistor; a supply circuit coupled to the supply terminal of the first amplifier; and a control circuit coupled to the control terminal of the second transistor and coupled to the first transistor, the control circuit capable of adjusting a voltage at the control terminal of the second transistor based on a current through the first transistor. Other examples are described.

### BRIEF DESCRIPTION OF THE DRAWINGS

FIG. 1 is a block diagram of an example system including an example power source, an example input protection circuit, an example low-dropout (LDO) regulator, an example load, and an example ground terminal.

FIG. 2 is a schematic diagram of a first example LDO regulator that can implement the LDO regulator of FIG. 1.

FIG. 3 is a schematic diagram of a second example LDO regulator that can implement the LDO regulator of FIG. 1.

FIG. 4 is a schematic diagram of a third example LDO regulator that can implement the LDO regulator of FIG. 1 and an example implementation of the resistance control circuit of FIG. 3.

FIG. 5 is an example timing diagram depicting example operation of the LDO regulator of FIG. 3.

FIG. 6 is a schematic diagram of a fourth example LDO regulator that can implement the LDO regulator of FIG. 1.

FIG. 7 is a flowchart representative of example machine-readable instructions or example operations that may be at least one of executed, instantiated, or performed using an example programmable circuitry implementation of the LDO regulator of FIG. 6.

The drawings are not necessarily to scale. Generally, the same reference numbers in the drawing(s) and this description refer to the same or similar (in terms of at least one of functional or structural) features or parts. Although the drawings show regions with clean lines and boundaries, some or all of these lines and boundaries may be idealized. In reality, the boundaries or lines may be unobservable, blended or irregular.

### DETAILED DESCRIPTION

Linear voltage regulators, also referred to as linear regulators, come in several forms, each serving specific needs within electronic systems. A series linear regulator, which uses a pass transistor placed in series with a load to control the voltage drop from input to output, is a common type of linear regulator. Series linear regulators rely on feedback to maintain a constant output voltage and are available in both fixed and adjustable approaches. Another type of linear regulator is a shunt regulator which operates by redirecting excess current away from a load to stabilize the voltage. While less common, shunt regulators are useful in low-current or simple voltage reference applications due to the relatively fewer components utilized in shunt regulators compared to other types of linear regulators.

Among linear regulators, low-dropout (LDO) regulators are a widely used type of linear regulator. LDO regulators (also referred to as LDOs) are designed to function with a small difference between input voltage and output voltage (for example, a few hundred millivolts). As such, LDO regulators are well-suited for systems with tight power margins. As a result of efficient regulation provided by LDO regulators, LDO regulators are often utilized in low-voltage, battery-powered electronics. An LDO regulator may include a bipolar junction transistor (BJT) or a field-effect transistor (FET) as a pass transistor that regulates output voltage. For example, an LDO regulator includes a positive-negative-positive (PNP) BJT or a positive-channel (p-channel) metal-oxide semiconductor field-effect transistor (MOSFET) as a pass transistor. In an LDO regulator, the conductance or on-resistance of the pass transistor is controlled by a regulation amplifier that compares the output voltage (V_{OUT}) from the LDO regulator to a reference voltage (V_{REF}) to regulate the output voltage (V_{OUT}) to meet the reference voltage (V_{REF}).

By using a BJT or a FET, an LDO regulator maintains regulation even when the input voltage (V_{IN}) is only slightly higher than the desired output voltage (V_{OUT}). As a result of the low noise, fast transient response, and compact design offered by LDO regulators, LDO regulators are frequently utilized in modern circuits. For example, LDO regulators are widely used in consumer electronics such as smartphones, wearable devices, and tablets, where LDO regulators supply stable voltage to processors, sensors, and radio frequency (RF) components. In automotive systems, LDO regulators provide clean power for safety-critical applications, infotainment, and advanced driver-assistance systems (ADAS). Medical devices and industrial instrumentation also rely on LDO regulators to power sensitive analog circuitry, to provide accuracy and noise immunity. LDO regulators deliver reliable and efficient power in applications where physical space, noise, and battery life are relevant considerations.

LDO regulators implement reverse current protection to prevent current from flowing from the output of an LDO regulator to the input of the LDO regulator in the event that the output voltage (V_{OUT}) from the LDO regulator falls below the input voltage (V_{IN}) to the LDO regulator. When an LDO regulator includes a BJT as the pass transistor, the BJT provides inherent reverse current protection. When an LDO regulator includes a FET as the pass transistor, the LDO regulator implements another FET for reverse current protection. For example, the two FETs are implemented in series (back-to-back) where the second FET is implemented as a reverse current protection FET that is operated as a switch to prevent reverse current flow through the body diode of the pass FET. The second FET also provides reverse voltage protection.

In a FET-based approach, the reverse current protection FET is controlled by a comparator that compares the output voltage (V_{OUT}) from the LDO regulator to the input voltage (V_{IN}) to the LDO regulator, and the comparator disables the reverse current protection FET when the output voltage (V_{OUT}) falls below the input voltage (V_{IN}). As described above, the pass transistor is controlled by a regulation amplifier that compares the output voltage (V_{OUT}) from the LDO regulator to a reference voltage (V_{REF}). In a FET-based approach, the regulation amplifier is supplied based on a midpoint voltage (V_{MID}) between the two FETs as the midpoint voltage (V_{MID}) is protected from negative input voltages (negative V_{IN}).

Depending on the process technology utilized, a BJT may consume less area on a die implementing an LDO regulator than back-to-back FETs. For example, for the same process technology a single BJT may consume less area than two FETs. However, a BJT has higher quiescent current (I_{Q}) when subjected to reverse voltage than back-to-back FETs. More particularly, the I_{Q} of a BJT is on the scale of milliamps (mA). Whereas the I_{Q} of back-to-back FETs is on the scale of nanoamps (nA). To achieve similar die size as a BJT-based approach, the size of other components can be reduced in a FET-based approach.

As described above, in a FET-based approach, the comparator of an LDO regulator disables the reverse current protection FET of the LDO regulator when a reverse current event manifests. Because of inherent characteristics of the comparator, there is a voltage offset (V_{OFFSET}) between the two voltages compared by the comparator. As such, the comparator does not disable the reverse current protection FET until the input voltage (V_{IN}) is slightly less than the output voltage (V_{OUT}) (V_{OUT}−V_{IN}>V_{OFFSET}). Thus, there is a period during which a FET-based LDO regulator may be subjected to reverse current. Equation 1 defines the peak reverse current (I_{REV}) to which a FET-based LDO regulator may be subjected. In Equation 1, R_{ON-LDO} represents the on-resistance of the LDO regulator.

$${I}_{REV} = \frac{{V}_{OFFSET}}{{R}_{ON - LDO}} \qquad ( Equation 1 )$$

For a voltage offset (V_{OFFSET}) of 25 millivolts (mV) and an on-resistance of 1.4 Ohms (Ω), the peak reverse current is 17.8 mA. To achieve a lower dropout (difference between the input voltage and output voltage), the area of the FETs in a FET-based LDO regulator can be increased. As the area of the FETs in a FET-based LDO regulator increases, the on-resistance of the LDO regulator decreases, and the peak reverse current to which the LDO regulator may be subjected increases. If the dropout of a FET-based LDO regulator originally having an on-resistance of 1.4Ω is reduced by 10 times, the on-resistance of the LDO regulator is 142.6 milliohms (mΩ). For a voltage offset (V_{OFFSET}) of 25 mV and an on-resistance of 142.6 mΩ, the peak reverse current is 175.3 mA. As such, the amount of reverse current to which a FET-based LDO regulator may be subjected directly scales with reducing the dropout.

When a reverse current event manifests, upstream components of an LDO regulator that operate responsive to the input voltage (V_{IN}) to the LDO regulator can be damaged by reverse current. To reduce the peak reverse current to which an LDO regulator may be subjected, the on-resistance of the LDO regulator can be increased. In a FET-based LDO regulator, the on-resistance of the reverse current protection FET is increased to increase the on-resistance of the LDO regulator. As described above, the regulation amplifier driving the pass FET of a FET-based LDO regulator is supplied based on the midpoint voltage (V_{MID}) between the two FETs. By increasing the on-resistance of the reverse current protection FET in a FET-based LDO regulator, control of the pass FET may be destabilized.

For example, introducing a finite resistance (a reverse current protection FET with a larger on-resistance) in the path between the input voltage (V_{IN}) and the midpoint voltage (V_{MID})) may create a positive feedback loop in the regulation amplifier driving the pass FET. The positive feedback loop or feedforward path introduces a zero in a control algorithm of the pass FET, which decreases stability of the control algorithm. Also, the gain of the feedforward path is proportional to the on-resistance of the reverse current protection FET. As such, increasing the on-resistance of the reverse current protection FET may increase the instability of the control algorithm of the pass FET.

Advantageously, examples described herein include a FET-based LDO regulator with a regulation amplifier that is supplied based on the input voltage (V_{IN}) to the LDO regulator. As such, a control algorithm for the pass FET of the LDO regulator does not include a feedforward path or positive feedback loop. Thus, the resistance of the reverse current protection FET of the LDO regulator can be increased to reduce the peak reverse current experienced by the LDO regulator. Examples described herein also dynamically regulate the resistance of the reverse current protection FET responsive to the current flowing through the pass FET. Examples described herein increase the resistance of the reverse current protection FET as the current through the pass FET decreases. Also, examples described herein decrease the resistance of the reverse current protection FET as the current through the pass FET increases. As such, if a reverse current event manifests, the resistance of the reverse current protection FET is high, and the peak reverse current through the reverse current protection FET is low in the period before the comparator disables the reverse current protection FET.

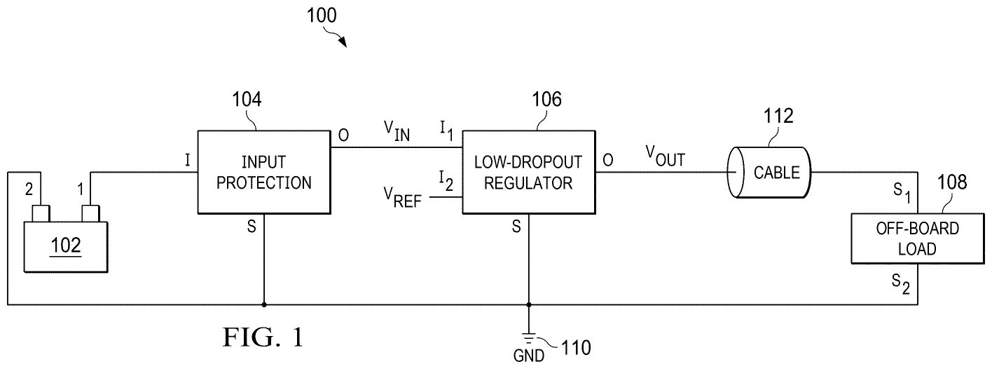

FIG. 1 is a block diagram of an example system 100 including an example voltage source 102, an example input protection circuit 104, an example low-dropout (LDO) regulator 106, an example load 108, and an example ground terminal 110. In the example of FIG. 1, the system 100 is a vehicle such as an automotive vehicle. In the example of FIG. 1, the voltage source 102 has a first terminal and a second terminal and the input protection circuit 104 has a supply terminal, an input, and an output. Also, in the example of FIG. 1, the LDO regulator 106 has a supply terminal, a first input, a second input, and an output, and the load 108 has a first supply terminal and a second supply terminal.

In the example of FIG. 1, the first terminal of the voltage source 102 is coupled to the input of the input protection circuit 104, and the second terminal of the voltage source 102 is coupled to the ground terminal 110. In the example of FIG. 1, the voltage source 102 provides a voltage in a vehicle. For example, the voltage source 102 is a lead-acid or other type of battery having a voltage such as 12V, 24V, 48V, etc. In some examples, the voltage source 102 is charged by an alternator of a vehicle that can increase the voltage of the voltage source 102 above a set voltage during operation. For example, an alternator charges a 12V battery to between 13.5V and 14.7V during operation.

In additional or alternative examples, the voltage source 102 is based on the main battery pack of an electric vehicle (EV) or a hybrid EV (HEV). For example, in an EV, the main battery pack has a voltage between 200V and 900V. In such examples, an EV includes a step-down converter to reduce the voltage of the main battery pack to a voltage to supply other components in the EV such as lights, infotainment systems, sensors, and electronic control units (ECUs). As such, in some examples, the voltage source 102 is a step-down converter or other switching regulator that reduces the voltage of the main battery pack of an EV or an HEV.

In the example of FIG. 1, the supply terminal of the input protection circuit 104 is coupled to the ground terminal 110, the input of the input protection circuit 104 is coupled to the first terminal of the voltage source 102, and the output of the input protection circuit 104 is coupled to the first input of the LDO regulator 106. In the example of FIG. 1, the input protection circuit 104 protects downstream components from potential damage caused by the voltage source 102. For example, the voltage supplied at the input of the input protection circuit 104 can vary and spike under certain conditions such as load dumps or jump starts. A load dump occurs, for example, when the voltage source 102 is disconnected and an alternator dumps residual current into the system 100. A jump start occurs, for example, when an external power source (such as the battery of another vehicle) is used to start a discharged or dead battery of a vehicle.

In the example of FIG. 1, the input protection circuit 104 may be implemented in a variety of manners. For example, the input protection circuit 104 is implemented by at least one of one or more transient voltage suppression (TVS) diodes, one or more metal-oxide varistors, or one or more crowbar circuits (such as a Zener diode and a thyristor) to protect against load dumps. In additional or alternative examples, the input protection circuit 104 is implemented by at least one of one or more Schottky diodes, one or more FETs, or one or more ideal diode controllers to provide reverse polarity protection. In some examples, the input protection circuit 104 is implemented by at least one of one or more overvoltage lockout (OVLO) circuits, one or more undervoltage lockout (UVLO) circuits, one or more fuses, or one or more current limiting circuits.

In the example of FIG. 1, the supply terminal of the LDO regulator 106 is coupled to the ground terminal 110, and the first input of the LDO regulator 106 is coupled to the output of the input protection circuit 104. In the example of FIG. 1, the second input of the LDO regulator 106 is coupled to a reference voltage terminal, and the output of the LDO regulator 106 is coupled to the first supply terminal of the load 108. For example, the output of the LDO regulator 106 is coupled to the first supply terminal of the load 108 via an example cable 112.

In the example of FIG. 1, the LDO regulator 106 is a FET-based LDO regulator. For example, the LDO regulator 106 is a flipped voltage follower (FVF) configured LDO regulator. In the example of FIG. 1, the LDO regulator 106 includes two FETs in series. In this configuration, the conductance or resistance of the pass FET is adjusted by a regulation amplifier to regulate the output voltage (V_{OUT}) from the LDO regulator 106 responsive to a reference voltage (V_{REF}). Also, the reverse current protection FET of the LDO regulator 106 is controlled by a comparator. In the example of FIG. 1, the LDO regulator 106 operates based on an input voltage (V_{IN}) provided by the input protection circuit 104.

In the example of FIG. 1, the first supply terminal of the load 108 is coupled to the output of the LDO regulator 106 (via the cable 112), and the second supply terminal of the load 108 is coupled to the ground terminal 110. In the example of FIG. 1, the load 108 may be implemented by a variety of circuits. For example, in an automotive application, the load 108 is a sensor such as a tire pressure sensor. In additional or alternative examples, the load 108 is an operational amplifier, an audio amplifier, an analog-to-digital converter (ADC), a digital-to-analog converter (DAC), a microcontroller, a microprocessor, a field programmable gate array (FPGA), an application specific integrated circuit (ASIC), a memory circuit, an RF transceiver, a low-noise amplifier, a phase-locked loop oscillator, a camera, an image sensor, a laser driver, an optical amplifier, or a display such as a liquid crystal diode (LCD) display or a light emitting diode (LED) display.

As described above, the output of the LDO regulator 106 is coupled to the first supply terminal of the load 108 via the cable 112. During operation of the system 100, a reverse current event can arise and the LDO regulator 106 may be subjected to a reverse voltage. For example, a reverse current event manifests when the first input of the LDO regulator 106 shorts to a low voltage such as the ground terminal 110. In another example, a reverse current event manifests when the output of the LDO regulator 106 shorts to a high voltage such as the voltage source 102. As described above, the LDO regulator 106 is coupled to the voltage source 102 via the input protection circuit 104. As such, the input voltage (V_{IN}) to the LDO regulator 106 may be a slightly lower than the voltage of the voltage source 102.

The above-described shorting may result from operation of the system 100 such as jostling, wear and tear over time, or improper construction, among others. When a reverse current event manifests, the comparator of the LDO regulator 106 disables the reverse current protection FET of the LDO regulator 106. Because of inherent characteristics of the comparator, there is a voltage offset (V_{OFFSET}) between the two voltages compared by the comparator that results in a period during which the LDO regulator 106 may be subjected to reverse current. Advantageously, the LDO regulator 106 includes a regulation amplifier that is supplied based on the input voltage (V_{IN}) to the LDO regulator 106. As such, a control algorithm for the pass FET of the LDO regulator 106 does not include a feedforward path or positive feedback loop. Thus, the resistance of the reverse current protection FET of the LDO regulator 106 can be increased to reduce the peak reverse current experienced by the LDO regulator 106.

Also or alternatively, the LDO regulator 106 includes a resistance control circuit to dynamically regulate the conductance or resistance of the reverse current protection FET responsive to the current flowing through the pass FET. For example, the resistance control circuit of the LDO regulator 106 increases the resistance of the reverse current protection FET as the current through the pass FET decreases. Also, for example, the resistance control circuit of the LDO regulator 106 decreases the resistance of the reverse current protection FET as the current through the pass FET increases. As such, if a reverse current event manifests, the resistance of the reverse current protection FET of the LDO regulator 106 is high, and the peak reverse current through the reverse current protection FET is low in the period before the comparator disables the reverse current protection FET.

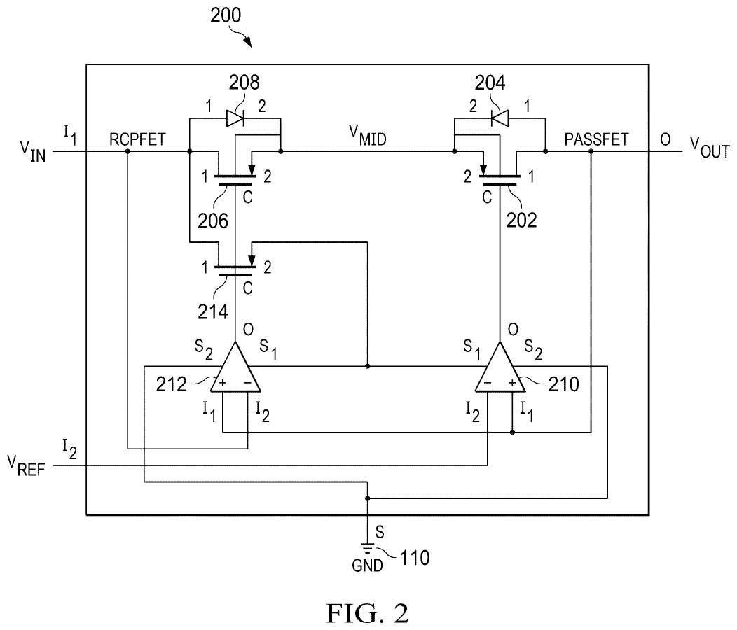

FIG. 2 is a schematic diagram of a first example LDO regulator 200 that can implement the LDO regulator 106 of FIG. 1. For example, the LDO regulator 200 of FIG. 2 eliminates the zero in a control algorithm of the pass FET of the LDO regulator 200 and improves the stability of the control algorithm. In the example of FIG. 2, the LDO regulator 200 includes a first example transistor 202, a second example transistor 206, a first example amplifier 210, a second example amplifier 212, and a third example transistor 214.

In the example of FIG. 2, each of the transistor 202, the transistor 206, and the transistor 214 has a control terminal, a first terminal, and a second terminal. For example, the control terminal is a gate terminal, the first terminal is a drain terminal, and the second terminal is a source terminal. In the example of FIG. 2, each of the transistor 202 and the transistor 206 also has a body terminal. Also, the transistor 202 has a body diode 204, and the transistor 206 has a body diode 208. The diodes 204 and 208 of FIG. 2 each have an effective or inherent first terminal (anode) and an effective or inherent second terminal (cathode). In the example of FIG. 2, each of the amplifier 210 and the amplifier 212 has a first input, a second input, and an output. Also, each of the amplifier 210 and the amplifier 212 of FIG. 2 has a first supply terminal and a second supply terminal.

In the example of FIG. 2, the control terminal of the transistor 202 is coupled to the output of the amplifier 210. In the example of FIG. 2, the first terminal of the transistor 202 is coupled to the first terminal of the diode 204, the first input of the amplifier 210, and the first input of the amplifier 212. Also, the first terminal of the transistor 202 is to act as the output of the LDO regulator 200. For example, the first terminal of the transistor 202 is adapted to be coupled to the first supply terminal of the load 108 (via the cable 112). In the example of FIG. 2, the second terminal of the transistor 202 is coupled to the second terminal of the diode 204, the second terminal of the transistor 206, and the second terminal of the diode 208. In the example of FIG. 2, the second terminal of the transistor 202 is also coupled to the body terminal of the transistor 202.

In the example of FIG. 2, the transistor 202 is a p-channel FET that is to operate as the pass FET of the LDO regulator 200. Also, the first terminal of the diode 204 is coupled to the first terminal of the transistor 202, the first input of the amplifier 210, and the first input of the amplifier 212. In the example of FIG. 2, the second terminal of the diode 204 is coupled to the second terminal of the transistor 202, the second terminal of the transistor 206, and the second terminal of the diode 208.

In the example of FIG. 2, the control terminal of the transistor 206 is coupled to the output of the amplifier 212. In the example of FIG. 2, the first terminal of the transistor 206 is coupled to the first terminal of the diode 208, the second input of the amplifier 212, and the first terminal of the transistor 214. Also, the first terminal of the transistor 206 is to act as the first input of the LDO regulator 200. For example, the first terminal of the transistor 206 is adapted to be coupled to the first terminal of the voltage source 102 via the output of the input protection circuit 104. In the example of FIG. 2, the second terminal of the transistor 206 is coupled to the second terminal of the diode 208, the second terminal of the transistor 202, and the second terminal of the diode 204. In the example of FIG. 2, the second terminal of the transistor 206 is also coupled to the body terminal of the transistor 206.

In the example of FIG. 2, the transistor 206 is a p-channel FET that is to operate as the reverse current protection (RCP) FET of the LDO regulator 200. Also, the first terminal of the diode 208 is coupled to the first terminal of the transistor 206, the second input of the amplifier 212, and the first terminal of the transistor 214. In the example of FIG. 2, the second terminal of the diode 208 is coupled to the second terminal of the transistor 206, the second terminal of the transistor 202, and the second terminal of the diode 204.

In the example of FIG. 2, the first supply terminal of the amplifier 210 is coupled to the second terminal of the transistor 214, and the second supply terminal of the amplifier 210 is adapted to be coupled to the ground terminal 110. For example, the second supply terminal of the amplifier 210 is to act as the supply terminal of the LDO regulator 200. In the example of FIG. 2, the first input of the amplifier 210 is coupled to the first terminal of the transistor 202, the first terminal of the diode 204, and the first input of the amplifier 212. Also, the second input of the amplifier 210 is adapted to be coupled to the reference voltage terminal. For example, the second input of the amplifier 210 is to act as the second input of the LDO regulator 200. In some examples, the second input of the amplifier 210 is referred to as a reference input.

In the example of FIG. 2, the first input and the second input of the amplifier 210 are the non-inverting and the inverting inputs of the amplifier 210, respectively. Also, the output of the amplifier 210 is coupled to the control terminal of the transistor 202. In the example of FIG. 2, the amplifier 210 is to operate as the regulation amplifier of the LDO regulator 200. For example, the amplifier 210 senses an output voltage (V_{OUT}) at the output of the LDO regulator 200 and a reference voltage (V_{REF}) at the second input of the LDO regulator 200 and adjusts the conductance or resistance of the transistor 202. In the example of FIG. 2, the amplifier 210 adjusts the resistance of the transistor 202 by adjusting a voltage at the control terminal of the transistor 202 responsive to the output voltage (V_{OUT}) and the reference voltage (V_{REF}). For example, the amplifier 210 adjusts the resistance of the transistor 202 to regulate the output voltage (V_{OUT}) to meet the reference voltage (V_{REF}).

In the example of FIG. 2, the first supply terminal of the amplifier 212 is coupled to the second terminal of the transistor 214 and the second supply terminal of the amplifier 212 is adapted to be coupled to the ground terminal 110. For example, the second supply terminal of the amplifier 212 is to act as the supply terminal of the LDO regulator 200. In the example of FIG. 2, the first input of the amplifier 212 is coupled to the first terminal of the transistor 202, the first terminal of the diode 204, and the first input of the amplifier 210. In the example of FIG. 2, the second input of the amplifier 210 is coupled to the first terminal of the transistor 206, the first terminal of the diode 208, and the first terminal of the transistor 214. Also, in the example of FIG. 2, the first input and the second input of the amplifier 212 are the non-inverting and the inverting inputs of the amplifier 212, respectively.

In the example of FIG. 2, the output of the amplifier 212 is coupled to the control terminal of the transistor 206 and the control terminal of the transistor 214. In the example of FIG. 2, the amplifier 212 is to operate as an RCP comparator of the LDO regulator 200. For example, the amplifier 212 senses the output voltage (V_{OUT}) at the output of the LDO regulator 200 and an input voltage at the first input of the LDO regulator 200 and disables at least one of the transistor 206 or the transistor 214 when the input voltage (V_{IN}) is less than the output voltage (V_{OUT}).

In the example of FIG. 2, the control terminal of the transistor 214 is coupled to the output of the amplifier 212. In the example of FIG. 2, the first terminal of the transistor 214 is coupled to the first terminal of the transistor 206, the first terminal of the diode 208, and the second input of the amplifier 212. Also, in the example of FIG. 2, the second terminal of the transistor 214 is coupled to the first supply terminal of the amplifier 210 and the first supply terminal of the amplifier 212. In the example of FIG. 2, the transistor 214 is a p-channel FET that is physically smaller than the transistor 206.

For example, the transistor 214 is between 20 times and 1,000 times smaller than the transistor

$$206 ( \frac{{Size}_{206}}{1 , 000} \leq {Size}_{214} \leq \frac{{Size}_{206}}{20} ) .$$

In the example of FIG. 2, the transistor 214 is 100 times smaller than the transistor

$$206 ( {Size}_{214} = \frac{{Size}_{206}}{100} ) .$$

For example, the area consumed on a chip by the transistor 214 (width dimension multiplied by length dimension) is 100 times smaller than the area consumed on a chip by the transistor 206 (width dimension multiplied by length dimension). A lower ratio between the sizes of the transistor 214 and the transistor 206 (Size₂₁₄:Size₂₀₆) corresponds to better matching between the transistor 214 and the transistor 206. A larger ratio between the sizes of the transistor 214 and the transistor 206 corresponds to a more area efficient design of the LDO regulator 200.

In the example of FIG. 2, the amplifier 210 is supplied based on the input voltage (V_{IN}) at the first input of the LDO regulator 200 minus the voltage drop across the transistor 214. Because the transistor 214 is physically smaller than the transistor 206, the transistor 214 conducts comparatively less current than the transistor 206. For example, the transistor 214 conducts a bias current and at least one of the transistor 206 or the diode 208 conducts a load current. In the example of FIG. 2, the bias current is about 50 microamps (μA) and the load current is between about 100 and 150 mA.

As described above, the amplifier 210 is supplied based on the input voltage (V_{IN}) to the LDO regulator 200 and not the midpoint voltage (V_{MID}) between the transistor 202 and the transistor 206. As such, the first supply terminal of the amplifier 210 is isolated from the midpoint voltage (V_{MID}). Therefore, the first supply terminal of the amplifier 210 is isolated from the varying conductance and thus, the varying resistance of the transistor 202. Thus, the positive feedback path present in other FET-based LDO regulators is not present in the LDO regulator 200.

Also, the zero present in the control algorithm of the pass FET of other LDO regulators is not present in the LDO regulator 200. Thus, the stability of the control algorithm of the transistor 202 (the pass FET of the LDO regulator 200) is improved relative to other LDO regulators. Because the LDO regulator 200 does not suffer from the instability present in other FET-based LDO regulators, the on-resistance of the RCP FET (the transistor 206) of the LDO regulator 200 can be increased to reduce the peak reverse current to which the LDO regulator 200 may be subjected. For example, the on-resistance of the RCP FET (the transistor 206) of the LDO regulator 200 can be increased without destabilizing the control algorithm of the pass FET (the transistor 202) of the LDO regulator 200.

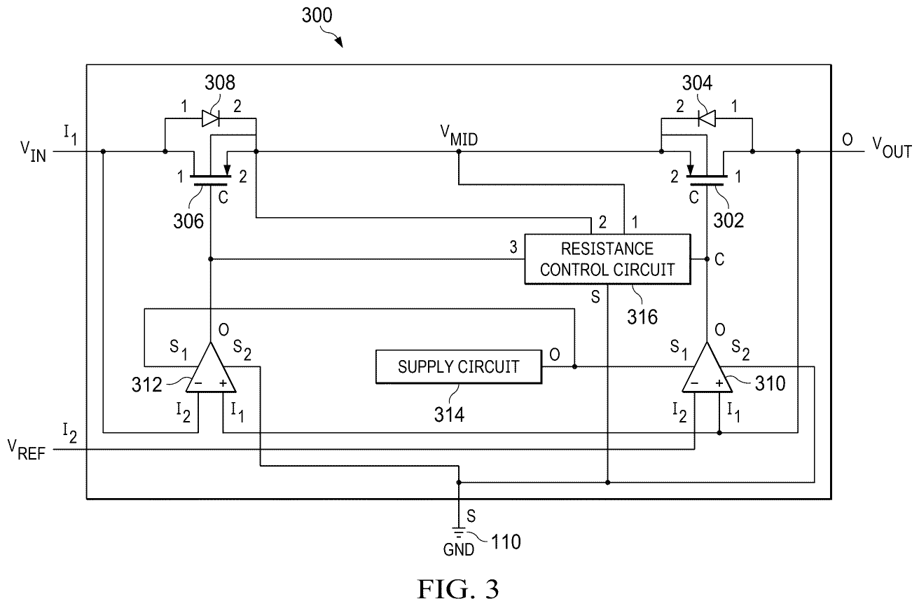

FIG. 3 is a schematic diagram of a second example LDO regulator 300 that can implement the LDO regulator 106 of FIG. 1. For example, the LDO regulator 300 of FIG. 3 dynamically regulates the resistance of the reverse current protection FET of the LDO regulator 300 responsive to the current flowing through the pass FET of the LDO regulator 300. In the example of FIG. 3, the LDO regulator 300 includes a first example transistor 302, a first example diode 304, a second example transistor 306, a second example diode 308, a first example amplifier 310, a second example amplifier 312, an example supply circuit 314, and an example resistance control circuit 316. In some examples, the resistance control circuit 316 is referred to as a control circuit.

In the example of FIG. 3, each of the transistor 302 and the transistor 306 has a control terminal, a first terminal, and a second terminal. For example, the control terminal is a gate terminal, the first terminal is a drain terminal, and the second terminal is a source terminal. In the example of FIG. 3, each of the transistor 302 and the transistor 306 also has a body terminal. Also, each of the diode 304 and the diode 308 of FIG. 3 has a first terminal and a second terminal. In the example of FIG. 3, each of the amplifier 310 and the amplifier 312 has a first input, a second input, and an output. Also, each of the amplifier 310 and the amplifier 312 of FIG. 3 has a first supply terminal and a second supply terminal. In the example of FIG. 3, the transistor 302, the diode 304, the transistor 306, the diode 308, the amplifier 310, and the amplifier 312 are implemented and coupled similarly to the transistor 202, the diode 204, the transistor 206, the diode 208, the amplifier 210, and the amplifier 212 of FIG. 2, respectively, unless described otherwise.

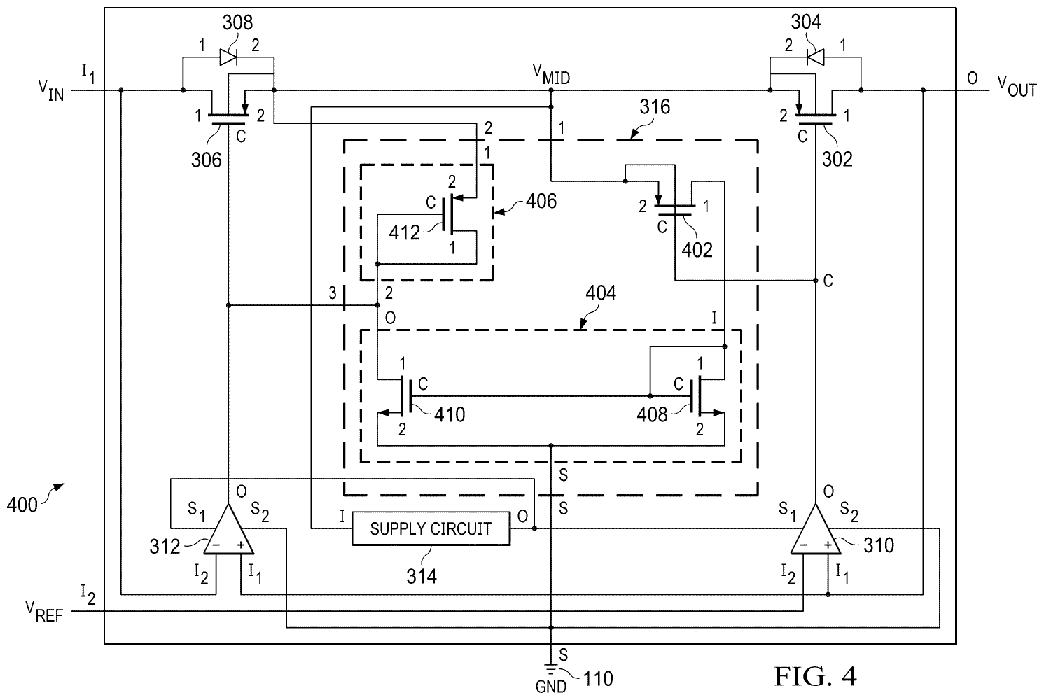

In the example of FIG. 3, the supply circuit 314 has an output. In the example of FIG. 3, the output of the supply circuit 314 is coupled to the first supply terminal of the amplifier 310 and the first supply terminal of the amplifier 312. In the example of FIG. 3, the supply circuit 314 is implemented by at least one of analog circuitry or digital circuitry and provides a supply voltage for the amplifier 310 and the amplifier 312. In some examples, the supply circuit 314 also has an input. For example, the input of the supply circuit 314 is coupled to the second terminal of the transistor 302, the second terminal of the diode 304, the second terminal of the transistor 306, the second terminal of the diode 308, the first terminal of the resistance control circuit 316, and the second terminal of the resistance control circuit 316. In such examples, the supply circuit 314 supplies the amplifier 310 based on the midpoint voltage (V_{MID}) between the transistor 302 and the transistor 306. FIG. 4 depicts such an example.

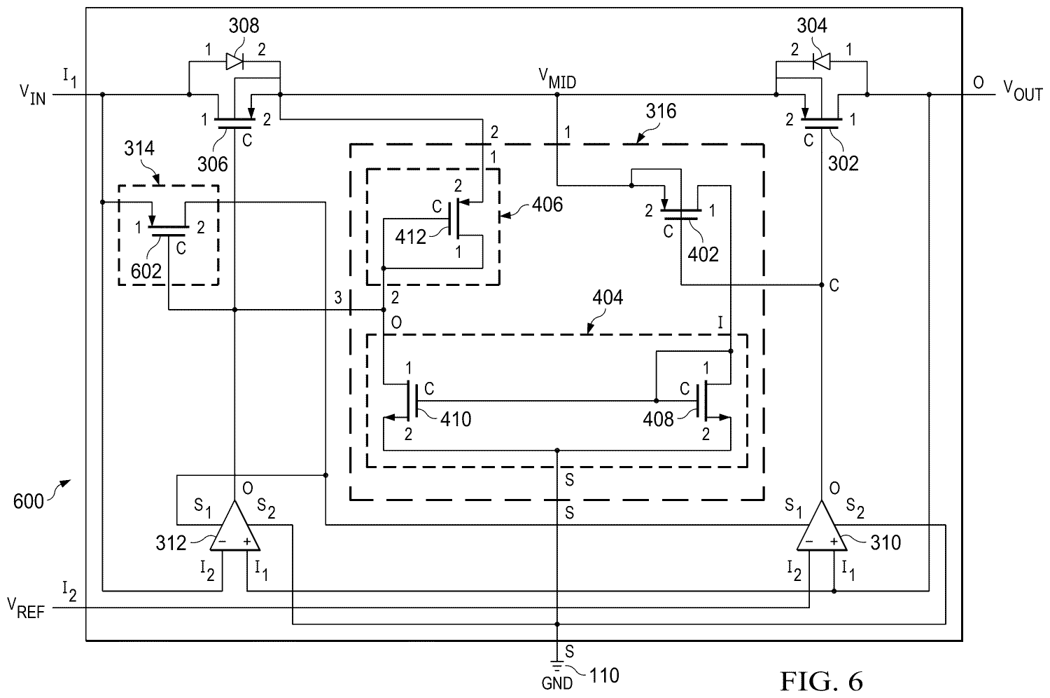

In some examples, the supply circuit 314 also has a control terminal. In such examples, the input of the supply circuit 314 is coupled to the first terminal of the transistor 306 and the control terminal of the supply circuit 314 is coupled to the output of the amplifier 312 and the third terminal of the resistance control circuit 316. In such examples, the supply circuit 314 supplies the amplifier 310 based on the input voltage (V_{IN}) at the first input of the LDO regulator 300. FIG. 6 depicts such an example.

In the example of FIG. 3, the resistance control circuit 316 of FIG. 3 has a control terminal, a supply terminal, a first terminal, a second terminal, and a third terminal. In the example of FIG. 3, the control terminal of the resistance control circuit 316 is coupled to the output of the amplifier 310 and the supply terminal of the resistance control circuit 316 is adapted to be coupled to the ground terminal 110. For example, the supply terminal of the resistance control circuit 316 is to act as the supply terminal of the LDO regulator 300. In the example of FIG. 3, the first terminal of the resistance control circuit 316 is coupled to the second terminal of the transistor 302, the second terminal of the diode 304, the second terminal of the transistor 306, the second terminal of the diode 308, and the second terminal of the resistance control circuit 316.

In the example of FIG. 3, the second terminal of the resistance control circuit 316 is coupled to the second terminal of the transistor 302, the second terminal of the diode 304, the second terminal of the transistor 306, the second terminal of the diode 308, and the first terminal of the resistance control circuit 316. In the example of FIG. 3, the third terminal of the resistance control circuit 316 is coupled to the control terminal of the transistor 306 and the output of the amplifier 312. As described above, in some examples, the first terminal of the resistance control circuit 316 and the second terminal of the resistance control circuit 316 are also coupled to the input of the supply circuit 314, for example, as depicted in FIG. 4. Also, as described above, in some examples, the third terminal of the resistance control circuit 316 is coupled to the output of the amplifier 312 and the control terminal of the supply circuit 314, for example, as depicted in FIG. 6.

In the example of FIG. 3, the resistance control circuit 316 is implemented by at least one of one or more transistors or one or more diodes. For example, the resistance control circuit 316 includes a transistor, a current mirror, and a diode. The example transistor senses current through the transistor 302, the current mirror mirrors the sensed current to the diode, and the diode dynamically drives the control terminal of the transistor 306 responsive to the sensed current. In some examples, the diode is implemented by a diode-connected transistor. In the example of FIG. 3, the transistor 302, the diode 304, the transistor 306, the diode 308, the amplifier 310, and the amplifier 312 are to operate similarly to the transistor 202, the diode 204, the transistor 206, the diode 208, the amplifier 210, and the amplifier 212 of FIG. 2, respectively, unless described otherwise.

In the example of FIG. 3, the resistance control circuit 316 dynamically modulates the resistance of the transistor 306 responsive to the current through the transistor 302. For example, the resistance control circuit 316 is capable of adjusting a voltage at the control terminal of the transistor 306 responsive to the current through the transistor 302. By adjusting the voltage at the control terminal of the transistor 306, the resistance control circuit 316 adjusts or modulates the resistance of the transistor 306. In the example of FIG. 3, the resistance control circuit 316 decreases the resistance of the transistor 306 as the current through the transistor 302 increases (during a larger load). As such, the resistance control circuit 316 does not impact the ability of the LDO regulator 300 to maintain a dropout specification of the LDO regulator 300. In the example of FIG. 3, the resistance control circuit 316 increases the resistance of the transistor 306 as the current through the transistor 302 decreases (during a light load).

In the example of FIG. 3, if a reverse current event manifests, reverse current flows from the output of the LDO regulator 300 through the diode 304 and is blocked by the diode 308. Because the resistance of the RCP FET (the transistor 306) is regulated by the resistance control circuit 316 to be high as the current through the pass FET (the transistor 302) decreases, the peak reverse current through the RCP FET (the transistor 306) is low in the period before the amplifier 312 disables the RCP FET (the transistor 306). For example, as the current through the pass FET (the transistor 302) decreases, the resistance control circuit 316 regulates the on-resistance of the RCP FET (the transistor 306) to be about 37.9Ω. As such, even if the amplifier 3122 has a voltage offset (V_{OFFSET}), the peak reverse current through the RCP FET (the transistor 306) is about 0.66 mA. After the amplifier 312 activates, the amplifier 312 disables the transistor 306 and maintains the transistor 306 in a disabled state until the reverse current event dissipates.

As described above, the amplifier 310 may be supplied based on the midpoint voltage (V_{MID}) between the transistor 302 and the transistor 306 or based on the input voltage (V_{IN}) at the first input of the LDO regulator 300. For example, when the amplifier 310 is supplied based on the midpoint voltage (V_{MID}), increasing the on-resistance of the RCP FET (the transistor 306) during resistance modulation may destabilize control of the pass FET (the transistor 302). To avoid destabilizing control of the pass FET (the transistor 302) in such examples, the resistance control circuit 316 modulates the resistance of the RCP FET (the transistor 306) to be less than or equal to about two to three times the minimum on-resistance of the RCP FET (the transistor 306). Also or alternatively, the LDO regulator 300 can implement the amplifier 310 with a very good stability margin to avoid destabilizing control of the pass FET (the transistor 302). When the amplifier 310 is supplied based on the input voltage (V_{IN}), the zero present in the control algorithm of the pass FET of other LDO regulators is not present in the LDO regulator 300. Thus, the stability of the control algorithm of the transistor 302 (the pass FET of the LDO regulator 300) is improved relative to other LDO regulators.

FIG. 4 is a schematic diagram of a third example LDO regulator 400 that can implement the LDO regulator 106 of FIG. 1 and an example implementation of the resistance control circuit 316 of FIG. 3. In the example of FIG. 4, the LDO regulator 400 includes the transistor 302, the diode 304, the transistor 306, the diode 308, the amplifier 310, the amplifier 312, and the resistance control circuit 316. The example resistance control circuit 316 of FIG. 4 includes a first example transistor 402, an example current mirror 404, and an example diode 406. In the example of FIG. 4, the transistor 402 has a control terminal, a first terminal, and a second terminal. For example, the control terminal is a gate terminal, the first terminal is a drain terminal, and the second terminal is a source terminal. Also, the transistor 402 has a body terminal. In the example of FIG. 4, the current mirror 404 has a supply terminal, an input, and an output. Also, the diode 406 has a first terminal and a second terminal. In the example of FIG. 4, the transistor 302, the diode 304, the transistor 306, the diode 308, the amplifier 310, and the amplifier 312 are implemented, coupled, and operate similarly as described in FIG. 3 unless described otherwise.

As described above, the supply circuit 314 of FIG. 4 has an input and an output. In the example of FIG. 4, the input of the supply circuit 314 is coupled to the second terminal of the transistor 302, the second terminal of the diode 304, the second terminal of the transistor 306, the second terminal of the diode 308, the first terminal of the resistance control circuit 316, and the second terminal of the resistance control circuit 316. In the example of FIG. 4, the supply circuit 314 supplies the amplifier 310 based on the midpoint voltage (V_{MID}) between the transistor 302 and the transistor 306.

In the example of FIG. 4, the control terminal of the transistor 402 is coupled to the output of the amplifier 310. For example, the control terminal of the transistor 402 is to act as the control terminal of the resistance control circuit 316. In the example of FIG. 4, the first terminal of the transistor 402 is coupled to the input of the current mirror 404. Also, in the example of FIG. 4, the second terminal of the transistor 402 is coupled to the second terminal of the transistor 302, the second terminal of the diode 304, the second terminal of the transistor 306, the second terminal of the diode 308, and the first terminal of the diode 406. For example, the second terminal of the transistor 402 is to act as the first terminal of the resistance control circuit 316. The second terminal of the transistor 402 is also coupled to the body terminal of the transistor 402.

In the example of FIG. 4, the transistor 402 is a p-channel FET that is physically smaller than the transistor 302. For example, the transistor 402 is between 20 times and 1,000 times smaller than the transistor

$$302 ( \frac{{Size}_{302}}{1 , 000} \leq {Size}_{402} \leq \frac{{Size}_{302}}{20} ) .$$

In the example of FIG. 4, the transistor 402 is 100 times smaller than the transistor

$$302 ( {Size}_{402} = \frac{{Size}_{302}}{100} ) .$$

For example, the area consumed on a chip by the transistor 402 (width dimension multiplied by length dimension) is 100 times smaller than the area consumed on a chip by the transistor 302 (width dimension multiplied by length dimension). A lower ratio between the sizes of the transistor 302 and the transistor 402 (Size₃₀₂:Size₄₀₂) corresponds to better matching between the transistor 302 and the transistor 402. For example, if the transistor 302 is 10 times larger than the transistor 402 (Size₃₀₂:Size₄₀₂=10), the transistor 302 and the transistor 402 is better matched. A larger ratio between the sizes of the transistor 302 and the transistor 402 corresponds to a more area efficient design of the LDO regulator 400. For example, if the transistor 302 is 1,000 times larger than the transistor 402 (Size₃₀₂:Size₄₀₂=1,000), the LDO regulator 400 is more area efficient.

In the example of FIG. 4, the transistor 402 senses the current passing through the transistor 302. Because the transistor 402 is physically smaller than the transistor 302, the transistor 402 conducts comparatively less current than the transistor 302. For example, the transistor 402 conducts a sense current and the transistor 302 conducts a load current. In the example of FIG. 4, the sense current is about 50 μA and the load current is between about 100 and 150 mA.

In the example of FIG. 4, the supply terminal of the current mirror 404 is adapted to be coupled to the ground terminal 110. For example, the supply terminal of the current mirror 404 is to act as the supply terminal of the resistance control circuit 316. In the example of FIG. 4, the input of the current mirror 404 is coupled to the first terminal of the transistor 402. Also, the output of the current mirror 404 is coupled to the second terminal of the diode 406 and the control terminal of the transistor 306. In the example of FIG. 4, the current mirror 404 includes a second example transistor 408 and a third example transistor 410.

In the example of FIG. 4, each of the transistor 408 and the transistor 410 has a control terminal, a first terminal, and a second terminal. For example, the control terminal is a gate terminal, the first terminal is a drain terminal, and the second terminal is a source terminal. In the example of FIG. 4, the control terminal of the transistor 408 is coupled to the first terminal of the transistor 402, the first terminal of the transistor 408, and the control terminal of the transistor 410. Also, the first terminal of the transistor 408 is coupled to the first terminal of the transistor 402, the control terminal of the transistor 408, and the control terminal of the transistor 410. For example, the first terminal of the transistor 408 is to act as the input of the current mirror 404. In the example of FIG. 4, the second terminal of the transistor 408 is coupled to the second terminal of the transistor 410 and is adapted to be coupled to the ground terminal 110.

In the example of FIG. 4, the control terminal of the transistor 410 is coupled to the first terminal of the transistor 402, the control terminal of the transistor 408, and the first terminal of the transistor 408. In the example of FIG. 4, the first terminal of the transistor 410 is coupled to the second terminal of the diode 406, the control terminal of the transistor 306, and the output of the amplifier 312. For example, the first terminal of the transistor 410 is to act as the output of the current mirror 404. In the example of FIG. 4, the second terminal of the transistor 410 is coupled to the second terminal of the transistor 408 and is adapted to be coupled to the ground terminal 110. For example, the second terminal of the transistor 408 and the second terminal of the transistor 410 are to act as the supply terminal of the current mirror 404.

In the example of FIG. 4, the transistor 408 and the transistor 410 are negative channel (n-channel) FETs that are matched. Depending on the ratio between the size of the transistor 410 and the size of the transistor 408 (Size₄₁₀:Size₄₀₈), the current received at the input of the current mirror 404 is mirrored to the output of the current mirror 404. For example, if the size (width dimension multiplied by length dimension) of the transistor 410 is larger than the size (width dimension multiplied by length dimension) of the transistor 408, the current mirrored to the output of the current mirror 404 is larger than the current received at the input of the current mirror 404 and vice versa. In the example of FIG. 4, the ratio between the size of the transistor 410 and the size of the transistor 408 is one (Size₄₁₀:Size₄₀₈=1).

In the example of FIG. 4, the first terminal of the diode 406 is coupled to the second terminal of the transistor 302, the second terminal of the diode 304, the second terminal of the transistor 306, the second terminal of the diode 308, the input of the supply circuit 314, and the second terminal of the transistor 402. For example, the first terminal of the diode 406 is to act as the second terminal of the resistance control circuit 316. In the example of FIG. 4, the second terminal of the diode 406 is coupled to the output of the current mirror 404 (the first terminal of the transistor 410), the control terminal of the transistor 306, and the output of the amplifier 312. For example, the second terminal of the diode 406 and the output of the current mirror 404 are to act as the third terminal of the resistance control circuit 316.

In the example of FIG. 4, the diode 406 is implemented by a fourth example transistor 412. The transistor 412 of FIG. 4 has a control terminal, a first terminal, and a second terminal. For example, the control terminal is a gate terminal, the first terminal is a drain terminal, and the second terminal is a source terminal. In the example of FIG. 4, the transistor 412 is a p-channel FET that is a diode-connected transistor. For example, the control terminal of the transistor 412 is coupled to the first terminal of the transistor 412. In the example of FIG. 4, the control terminal of the transistor 412 is also coupled to the first terminal of the transistor 410, the control terminal of the transistor 306, and the output of the amplifier 312.

In the example of FIG. 4, the first terminal of the transistor 412 is coupled to the control terminal of the transistor 412, the first terminal of the transistor 410, the control terminal of the transistor 306, and the output of the amplifier 312. For example, the first terminal of the transistor 412 is to act as the second terminal of the diode 406. In the example of FIG. 4, the second terminal of the transistor 412 is coupled to the second terminal of the transistor 302, the second terminal of the diode 304, the second terminal of the transistor 306, the second terminal of the diode 308, the input of the supply circuit 314, and the second terminal of the transistor 402. For example, the second terminal of the transistor 412 is to act as the first terminal of the diode 406. In some examples, the diode 406 is implemented by a diode.

In the example of FIG. 4, the transistor 402 senses current through the transistor 302 and provides the sensed current to the input of the current mirror 404. In the example of FIG. 4, the current mirror 404 mirrors the sensed current to the output of the current mirror 404. For example, the current mirrored by the current mirror 404 sets the current through the diode 406. In the example of FIG. 4, the diode 406 dynamically drives the control terminal of the transistor 306 responsive to the current mirrored by the current mirror 404. For example, the diode 406 adjusts the voltage at the control terminal of the transistor 306 responsive to the current through the transistor 302 as sensed by the transistor 402 and mirrored by the current mirror 404. As described herein, the resistance control circuit 316 implements open loop control of the resistance of the transistor 306 (the RCP FET of the LDO regulator 400).

For example, the transistor 402 senses the current through the transistor 302, and the diode 406 loosely drives the control terminal of the transistor 306 responsive to the sensed current as mirrored by the current mirror 404. By implementing open loop control of the resistance of the transistor 306, the resistance control circuit 316 consumes less area on a chip than other approaches that implement closed loop control to regulate values. For example, closed loop control utilizes an amplifier with a negative feedback loop. An amplifier consumes more area on a chip than the combined area consumed by a transistor, a current mirror, and a diode.

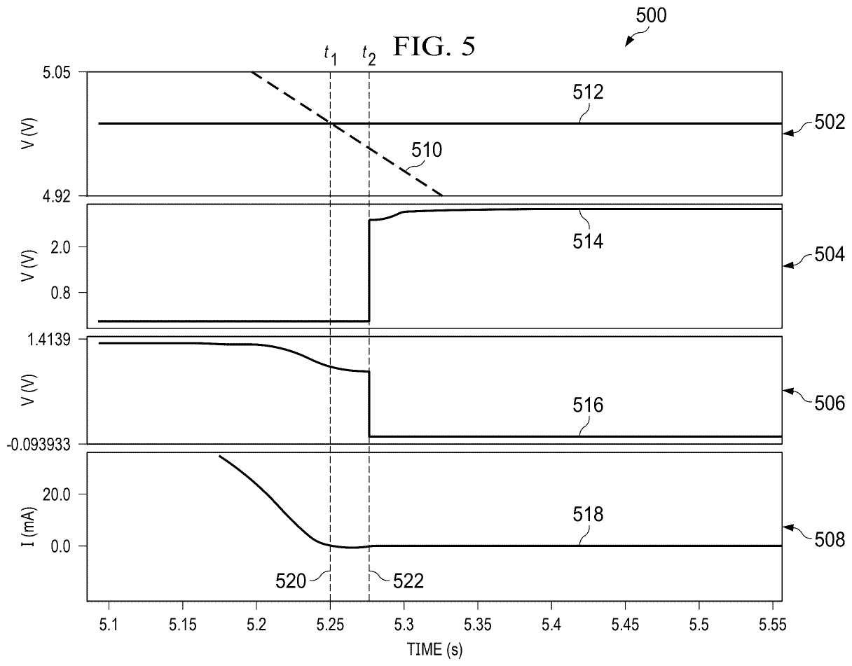

FIG. 5 is an example timing diagram 500 depicting example operation of the LDO regulator 300 of FIG. 3. In the example of FIG. 5, the timing diagram 500 includes a first example graph 502, a second example graph 504, a third example graph 506, and a fourth example graph 508. In the example of FIG. 5, the graph 502, the graph 504, and the graph 506 depict voltage in volts (V) versus time in seconds (s). The graph 502 includes a first example plot 510 depicting the input voltage (V_{IN}) to the LDO regulator 300 and a second example plot 512 depicting the output voltage (V_{OUT}) from the LDO regulator 300. The graph 504 includes a third example plot 514 depicting a control signal provided by the amplifier 312.

In the example of FIG. 5, the graph 506 includes a fourth example plot 516 depicting the gate-to-source voltage (V_{GS}) of the transistor 306. In the example of FIG. 5, the graph 508 depicts current in mA versus time in seconds (s). The graph 508 includes a fifth example plot 518 depicting the current through the transistor 302. As illustrated in FIG. 5, the LDO regulator 300 regulates the output voltage (V_{OUT}) from the LDO regulator 300 (plot 512) to 5 V while the input voltage (V_{IN}) to the LDO regulator 300 (plot 510) is ramping down at a rate of 1 V/s. At a first example time 520 (11), the input voltage (V_{IN}) to the LDO regulator 300 (plot 510) falls below the output voltage (V_{OUT}) from the LDO regulator 300 (plot 512). In the example of FIG. 5, the amplifier 312 includes a voltage offset (V_{OFFSET}) of 25 mV. As such, the amplifier 312 does not disable the transistor 306 until a second example time 522 (12).

Thus, the LDO regulator 300 may be subject to reverse current in the period between the time 520 (11) and the time 522 (12). Advantageously, the resistance control circuit 316 senses the current through the transistor 302 (plot 518) and as the current decreases, the resistance control circuit 316 decreases the gate-to-source voltage (V_{GS}) of the transistor 306 (plot 516). As such, the resistance control circuit 316 reduces the peak reverse current through the LDO regulator 300 in the period between the time 520 (11) and the time 522 (12). For example, because the resistance control circuit 316 decreases the gate-to-source voltage (V_{GS}) of the transistor 306 (plot 516) as the current through the transistor 302 (plot 518) decreases, the resistance of the transistor 306 is increased.

As a result, the conductance of the transistor 306 is decreased before the reverse current event manifests at the time 520 (t₁). Thus, the peak reverse current through the LDO regulator 300 is about 664 microamps (μA) or 0.664 mA. A peak reverse current of 66.4 mA is about 25 times lower than the peak reverse current (17.5 mA) of other LDO regulators having comparators with the same voltage offset (V_{OFFSET}). After the time 522 (12), the amplifier 312 activates, disables the transistor 306, and maintains the transistor 306 in a disabled state until the reverse current event dissipates.

FIG. 6 is a schematic diagram of a fourth example LDO regulator 600 that can implement the LDO regulator 106 of FIG. 1. For example, the LDO regulator 600 of FIG. 6 eliminates the zero in a control algorithm of the pass FET of the LDO regulator 600, improves the stability of the control algorithm, and dynamically regulates the resistance of the reverse current protection FET of the LDO regulator 600 responsive to the current flowing through the pass FET of the LDO regulator 600. In the example of FIG. 6, the LDO regulator 600 includes the transistor 302, the diode 304, the transistor 306, the diode 308, the amplifier 310, the amplifier 312, and the resistance control circuit 316. In the example of FIG. 6, the transistor 302, the diode 304, the transistor 306, the diode 308, the amplifier 310, the amplifier 312, and the resistance control circuit 316 are implemented, coupled, and operate similarly as described in FIG. 3 unless described otherwise.

In the example of FIG. 6, the resistance control circuit 316 includes the transistor 402, the current mirror 404, and the diode 406. Also, the current mirror 404 includes the transistor 408 and the transistor 410 and the diode 406 is implemented by the transistor 412. In the example of FIG. 6, the transistor 402, the current mirror 404, the diode 406, the transistor 408, the transistor 410, and the transistor 412 are implemented, coupled, and operate similarly as described in FIG. 4 unless described otherwise.

In the example of FIG. 6, the supply circuit 314 of the LDO regulator 600 includes an example transistor 602. The example transistor 602 of FIG. 6 is a p-channel FET that has a control terminal, a first terminal, and a second terminal. For example, the control terminal is a gate terminal, the first terminal is a drain terminal, and the second terminal is a source terminal. As described above, the supply circuit 314 of FIG. 6 has a control terminal, an input, an output. For example, the control terminal, the first terminal, and the second terminal of the transistor 602 are to act as the control terminal, the input, and the output of the supply circuit 314, respectively. In the example of FIG. 6, the transistor 602 is implemented, coupled, and operates similarly to the transistor 214 of FIG. 2 unless described otherwise.

In the example of FIG. 6, the resistance control circuit 316 dynamically modulates the resistance of the transistor 306 responsive to the current through the transistor 302. As described above, the resistance control circuit 316 increases the resistance of the transistor 306 as the current through the transistor 302 decreases. As such, if a reverse current event manifests, the resistance of the RCP FET (the transistor 306) is regulated by the resistance control circuit 316 to be high as the current through the pass FET (the transistor 302) decreases and the peak reverse current through the RCP FET (the transistor 306) is low in the period before the amplifier 312 disables the RCP FET (the transistor 306).

In the example of FIG. 6, the amplifier 310 is supplied based on the input voltage (V_{IN}) at the first input of the LDO regulator 600 minus the voltage drop across the transistor 602. As such, the amplifier 310 is not supplied based on the midpoint voltage (V_{MID}) between the transistor 302 and the transistor 306. Thus, the first supply terminal of the amplifier 310 is isolated from the midpoint voltage (V_{MID}) as the conductance and thus, the resistance of the transistor 302 varies during operation. As such, the positive feedback path present in other FET-based LDO regulators is not present in the LDO regulator 600 of FIG. 6. Also, the zero present in the control algorithm of the pass FET of other LDO regulators is not present in the LDO regulator 600 of FIG. 6. Thus, the stability of the control algorithm of the pass FET (the transistor 302) is improved relative to other LDO regulators.

Because the LDO regulator 600 does not suffer from the instability present in other FET-based LDO regulators, the on-resistance of the RCP FET (the transistor 306) of the LDO regulator 600 can be increased dynamically to reduce the peak reverse current to which the LDO regulator 600 may be subjected. For example, the on-resistance of the RCP FET (the transistor 306) of the LDO regulator 600 can be increased without destabilizing the control algorithm of the pass FET (the transistor 302) of the LDO regulator 600. Also, because there is no risk of destabilizing control of the pass FET (the transistor 302) by increasing the on-resistance of the RCP FET (the transistor 306), the resistance control circuit 316 may modulate the resistance of the RCP FET (the transistor 306) to as large a value as dictated by the current mirrored through the current mirror 404 and sensed by the transistor 402 during operation. In other words, the resistance of the RCP FET (the transistor 306) may exceed two to three times the minimum on-resistance of the RCP FET (the transistor 306) during resistance modulation.

As the resistance control circuit 316 modulates the resistance of the RCP FET (the transistor 306), there may be a tradeoff in the load transient undershoot performance of the LDO regulator 600. For example, as the resistance control circuit 316 increases the resistance of the RCP FET (the transistor 306), the load transient undershoot of the LDO regulator 600 may also increase. Table 1 includes the load transient undershoot performance of the LDO regulator 600 for a 0-200 mA load transient that occurs over one microsecond (μs) on a one microfarad (μF) load capacitor having an equivalent series resistance (ESR) of 10 mΩ.

TABLE 1

| Resistance of the Transistor 306 | Load Transient Undershoot |
|---|---|
| 1.5 Ω | 310 mV |
| 15 Ω | 345 mV |
| 30 Ω | 360 mV |
| 46 Ω | 370 mV |

As described above, the resistance control circuit 316 implements open loop control of the resistance of the transistor 306 (the RCP FET of the LDO regulator 600) by loosely driving the control terminal of the transistor 306 responsive to the sensed current as mirrored by the current mirror 404. By implementing open loop control of the resistance of the transistor 306, the resistance control circuit 316 consumes less area on a chip than other approaches that implement closed loop control to regulate values. For example, the resistance control circuit 316 consumes about 5,000 square micrometers (μm²) whereas a closed loop control implementation consumes about 38,000 μm². Stated differently, the resistance control circuit 316 consumes 7.6 times less area on a chip than a closed loop control implementation.

Additional or alternative LDO regulators implement different techniques to stabilize control of the pass FET of an LDO regulator. For example, an LDO regulator may be coupled to a high voltage capacitor with an ESR that aids in stabilizing control of the pass FET. To support utilization of capacitors with a wide range of ESR, an LDO regulator may include circuitry to realize a pseudo ESR that also aids in stabilizing control of the pass FET. The pseudo ESR of an LDO regulator refers to an effective internal resistance implemented at the output stage of the LDO regulator to aid in stabilizing control of the pass FET of the LDO regulator. A larger pseudo ESR provides greater stability in an LDO regulator. However, when an LDO regulator implementing a pseudo ESR is subjected to a transient, the pseudo ESR reacts poorly and degrades the response of the LDO regulator to the transient.

In examples described herein, control of the LDO regulator 600 is stabilized by supplying the amplifier 310 based on the input voltage (V_{IN}) to the LDO regulator 600 and not the midpoint voltage (V_{MID}). As such, the LDO regulator 600 may not include any circuitry to implement a pseudo ESR. If the LDO regulator 600 does implement a pseudo ESR, the pseudo ESR may be very small compared to other approaches. As such, the response of the LDO regulator 600 to transients is improved as compared to other approaches that implement large pseudo ESRs.

In addition to pseudo ESR, examples described herein also improve other parameters of an LDO regulator without impacting performance of the LDO regulator. Table 2 below provides a comparison between an LDO regulator that implements a midpoint voltage (V_{MID}) supplied amplifier and the LDO regulator 200 of FIG. 2 and the LDO regulator 600 of FIG. 6 where the amplifier 210 and the amplifier 310, respectively, are supplied based on the input voltage (V_{IN}) to the LDO regulator.

TABLE 2

| | LDO regulator with | | LDO regulator 200/ | |
|---|---|---|---|---|
| Parameter | V_{MID} supplied amplifier | | LDO regulator 600 | |
| Minimum C_{LOAD} | >0.5 | μF | >0.25 | μF |
| R_{ESR} | 0-2 | Ω | 0-3.5 | Ω |
| Load Transient | 310 | mV | 230 | mV |
| Undershoot | | | | |
| Minimum Phase Margin | 13 | degrees | 42 | degrees |

As illustrated in Table 2, the LDO regulators 200, 600 support a minimum load capacitance that is two times smaller than the minimum load capacitance supported by other LDO regulators. Also, the LDO regulators 200, 600 supports capacitors having an ESR range that is 1.75 times larger than the ESR range supported by other LDO regulators. As illustrated in Table 2, the LDO regulators 200, 600 has a load transient undershoot that is 1.35 times smaller than the load transient undershoot of other LDO regulators. For example, the load transient undershoot corresponds to a 0-200 mA load transient that occurs over 1 μs on a 1 μF load capacitor having an ESR of 10 mΩ. As illustrated in Table 2, the LDO regulators 200, 600 has a minimum phase margin that is 30 degrees larger than the minimum phase margin of other LDO regulators. For example, the minimum phase margin corresponds to a load current of 480 mA and a 0.5 μF load capacitor with an ESR of 2Ω.

As described above in the example of FIG. 4, the transistors 408 and 410 are n-channel MOSFETs. Alternatively, the transistors 408 and 410 may be n-channel FETs, n-channel insulated-gate bipolar transistors (IGBTs), n-channel junction field effect transistors (JFETs), negative-positive-negative (NPN) BJTs or, with slight modifications, P-type equivalent devices. Also, as described above in the examples of FIGS. 2-4 and FIG. 6, the transistors 202, 206, 214, 302, 306, 402, 412, and 602 are p-channel MOSFETs. Alternatively, the transistors 202, 206, 214, 302, 306, 402, 412, and 602 may be p-channel FETs, p-channel IGBTs, p-channel JFETs, PNP BJTs, or, with slight modifications, N-type equivalent devices. The transistors 202, 206, 214, 302, 306, 402, 408, 410, 412, and 602 may be depletion mode devices, drain-extended devices, enhancement mode devices, natural transistors, or other type of device structure transistors. Furthermore, the transistors 202, 206, 214, 302, 306, 402, 408, 410, 412, and 602 may be implemented in/over a silicon (Si) substrate, a silicon carbide (SIC) substrate, a gallium nitride (GaN) substrate or a gallium arsenide (GaAs) substrate.

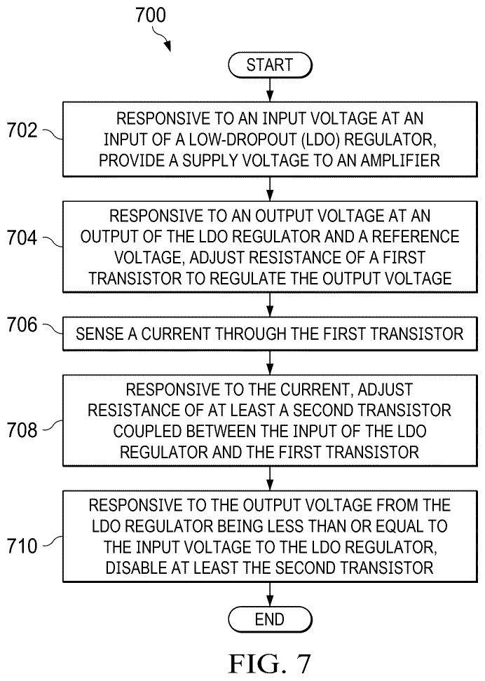

FIG. 7 is a flowchart representative of example machine-readable instructions or example operations 700 that may be at least one of executed, instantiated, or performed using an example programmable circuitry implementation of the LDO regulator 600 of FIG. 6. The example machine-readable instructions or the example operations 700 of FIG. 7 begin at block 702, at which, responsive to an input voltage (V_{IN}) at an input of a LDO regulator, the transistor 602 provides a supply voltage to an amplifier. For example, responsive to the input voltage (V_{IN}) at the first input of the LDO regulator 600, the transistor 602 provides a supply voltage to the amplifier 310.

In the example of FIG. 7, at block 704, responsive to an output voltage (V_{OUT}) at an output of the LDO regulator and a reference voltage (V_{REF}), the amplifier adjusts resistance of a first transistor to regulate the output voltage (V_{OUT}). For example, responsive to an output voltage (V_{OUT}) at the output of the LDO regulator 600 and a reference voltage (V_{REF}) at the second input of the LDO regulator 600, the amplifier 310 adjusts resistance of the transistor 302 to regulate the output voltage (V_{OUT}). In the example of FIG. 7, at block 706, the transistor 402 senses a current through the first transistor. For example, the transistor 402 senses a current through the transistor 302.

In the example of FIG. 7, at block 708, responsive to the current, the diode 406 adjusts resistance of at least a second transistor between the input of the LDO regulator and the first transistor. For example, responsive to the current, the diode 406 adjusts resistance of at least the transistor 306 which is between the first input of the LDO regulator 600 and the transistor 302. As described above, the diode 406 is implemented by the transistor 412 which is a diode-connected transistor. Also, as described above, the diode 406 adjusts resistance of at least the transistor 306 by adjusting a voltage at the control terminal of the transistor 306 responsive to the current through the transistor 302. In the example of FIG. 7, at block 710, responsive to the output voltage (V_{OUT}) from the LDO regulator being less than or equal to the input voltage (V_{IN}) to the LDO regulator, the amplifier 312 disables the second transistor. For example, responsive to the output voltage (V_{OUT}) from the LDO regulator 600 being less than or equal to the input voltage (V_{IN}) to the LDO regulator 600, the amplifier 312 disables the transistor 306.

While example manners of implementing the LDO regulator 106 of FIG. 1 are illustrated in FIGS. 2, 3, and 6, one or more of the elements, processes, or devices illustrated in FIGS. 2, 3, and 6 may be combined, divided, re-arranged, omitted, eliminated, or implemented in any other way. Also, while an example manner of implementing the resistance control circuit 316 of FIG. 3 is illustrated in FIGS. 4 and 6, one or more of the elements, processes, or devices illustrated in FIGS. 4 and 6 may be combined, divided, re-arranged, omitted, eliminated, or implemented in any other way. Further, one or more of the elements, processes, or devices of FIGS. 2, 3, 4, and 6, may be implemented by hardware alone or by hardware in combination with software and firmware. Thus, for example, any of the elements, processes, or devices of FIGS. 2, 3, 4, and 6, could be implemented by programmable circuitry in combination with one or more machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), or field programmable logic device(s) (FPLD(s)) such as FPGAs. Further still, at least one of the example LDO regulator of FIGS. 2, 3, and 6 or the example resistance control circuit 316 of FIGS. 4 and 6 may include one or more elements, processes, or devices in addition to, or instead of, those illustrated in FIGS. 2, 3, 4, and 6, or may include more than one of any or all of the illustrated elements, processes and devices.

A flowchart representative of example machine-readable instructions, which may be executed by programmable circuitry to at least one of implement or instantiate the LDO regulator of FIGS. 2, 3, 4, and 6 or representative of example operations which may be performed by programmable circuitry to at least one of implement or instantiate the LDO regulator of FIGS. 2, 3, 4, and 6, is shown in FIG. 7. The machine-readable instructions may be one or more executable programs or portion(s) of one or more executable programs for execution by programmable circuitry and may be one or more function(s) or portion(s) of functions to be performed by the example programmable circuitry (e.g., an FPGA). In some examples, the machine-readable instructions cause an operation, a task, etc., to be carried out or performed in an automated manner in the real-world. As used herein, “automated” means without human involvement.

The program may be embodied in instructions (e.g., at least one of software or firmware) stored on one or more non-transitory computer-readable or machine-readable storage medium such as one of or a combination of cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), or any other storage device or storage disk. The instructions of the non-transitory computer-readable or machine-readable medium may program or be executed by programmable circuitry located in one or more hardware devices, but the entire program or parts thereof could alternatively be executed or instantiated by one or more hardware devices other than the programmable circuitry or embodied in dedicated hardware. The machine-readable instructions may be distributed across multiple hardware devices or executed by two or more hardware devices (e.g., a server and a client hardware device). For example, the client hardware device may be implemented by an endpoint client hardware device (e.g., a hardware device associated with at least one of a human user or a machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart illustrated in FIG. 7, many other methods of implementing the example LDO regulator may alternatively be used. For example, the order of execution of the blocks of the flowchart(s) may be changed, or some of the blocks described may be changed, climinated, or combined. Also or alternatively, any or all of the blocks of the flow chart may be implemented by one or more hardware circuits (e.g., processor circuitry, discrete analog circuitry, discrete digital circuitry, integrated analog circuitry, integrated digital circuitry, an FPGA, an ASIC, a comparator, an operational-amplifier (op-amp), a logic circuit, etc.) structured to perform the corresponding operation without executing software or firmware. The programmable circuitry may be distributed in different network locations or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, one of or a combination of a CPU or an FPGA. The programmable circuitry may include one or more CPUs or one or more FPGAs located in the same package (e.g., the same integrated circuit (IC) package or in two or more separate housings), one or more CPUs or FPGAs in a single machine, one or multiple CPUs or FPGAs distributed across multiple servers of a server rack, multiple processors distributed across one or more server racks. Also or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller unit (MCU), a programmable system on chip (PSoC), etc., or any combination(s) thereof in any of the contexts described above.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, or produce machine-executable instructions. For example, the machine-readable instructions may be fragmented and stored on one or more storage devices, disks, or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to render them directly readable, interpretable, or executable by a computing device or other machine. For example, the machine-readable instructions may be stored in multiple parts, which are individually compressed, encrypted, or stored on separate computing devices, where the parts when decrypted, decompressed, or combined form a set of one or more computer-executable or machine-executable instructions that implement one or more functions or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions or the corresponding program(s) can be executed in whole or in part. Thus, machine-readable, computer-readable, or machine-readable media, as used herein, may include one or a combination of instructions and program(s) regardless of the particular format or state of the machine-readable instructions or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIG. 7 may be implemented using executable instructions (e.g., at least one of computer-readable or machine-readable instructions) stored on one or more non-transitory computer-readable or machine-readable media. As used herein, the terms non-transitory computer-readable medium, non-transitory computer-readable storage medium, non-transitory machine-readable medium, and non-transitory machine-readable storage medium are expressly defined to include any type of computer-readable storage device or storage disk and to exclude propagating signals and to exclude transmission media. Examples of such non-transitory computer-readable medium, non-transitory computer-readable storage medium, non-transitory machine-readable medium, or non-transitory machine-readable storage medium include one or more optical storage devices, magnetic storage devices, an HDD, a flash memory, a read-only memory (ROM), a CD, a DVD, a cache, a RAM of any type, a register, or any other storage device or storage disk in which information is stored for any duration (e.g., for extended time periods, permanently, for brief instances, for temporarily buffering, for caching of the information). As used herein, the terms “non-transitory computer-readable storage device” and “non-transitory machine-readable storage device” are defined to include any physical (mechanical, magnetic, electromechanical, or electrical) hardware to retain information for a time period, but to exclude propagating signals and to exclude transmission media. Examples of non-transitory computer-readable storage devices or non-transitory machine-readable storage devices include one or a combination of random-access memory of any type, read only memory of any type, solid state memory, flash memory, optical discs, magnetic disks, disk drives, or redundant array of independent disks (RAID) systems. As used herein, the term “device” refers to physical structure such as one of or a combination of mechanical, electromechanical, or electrical equipment, hardware, or circuitry that may or may not be configured by computer-readable instructions, machine-readable instructions, etc., or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. As used herein in the context of describing structures, components, items, objects and things, the phrase “at least one of A and B” refers to implementations including any of (1) at least one A, (2) at least one B, or (3) at least one A and at least one B. Similarly, as used herein in the context of describing structures, components, items, objects and things, the phrase “at least one of A or B” refers to implementations including any of (1) at least one A, (2) at least one B, or (3) at least one A and at least one B. As used herein in the context of describing the performance or execution of processes, instructions, actions, activities, etc., the phrase “at least one of A and B” refers to implementations including any of (1) at least one A, (2) at least one B, or (3) at least one A and at least one B. Similarly, as used herein in the context of describing the performance or execution of processes, instructions, actions, activities, etc., the phrase “at least one of A or B” refers to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Also, although individual features may be included in different examples or claims, these may possibly be combined, and the inclusion in different examples or claims does not imply that a combination of features is at least one of not feasible or advantageous.

As used herein, connection references (e.g., attached, coupled, connected, and joined) may include intermediate members between the elements referenced by at least one of the connection reference or relative movement between those elements unless otherwise indicated. As such, connection references do not necessarily infer that two elements are directly connected or in fixed relation to each other.

Unless specifically stated otherwise, descriptors such as “first,” “second,” “third,” “fourth,” “fifth,” “sixth,” “seventh,” etc., are used herein without imputing or otherwise indicating any meaning of priority, physical order, arrangement in a list, or ordering in any way, but are merely used as at least one of labels or arbitrary names to distinguish elements for case of understanding the described examples. In some examples, the descriptor “first” may be used to refer to an element in the detailed description, while the same element may be referred to in a claim with a different descriptor such as “second” or “third.” In such instances, such descriptors are used merely for identifying those elements distinctly within the context of the description (e.g., within a claim) in which the elements might, for example, otherwise share a same name.

As used herein, the phrase “in communication,” including variations thereof, encompasses one of or a combination of direct communication or indirect communication through one or more intermediary components, and does not require direct physical (e.g., wired) communication or constant communication, but rather also includes selective communication at least one of periodic intervals, scheduled intervals, aperiodic intervals, or one-time events.

As used herein, “programmable circuitry” is defined to include at least one of (i) one or more special purpose electrical circuits (e.g., an application specific circuit (ASIC)) structured to perform specific operation(s) and including one or more semiconductor-based logic devices (e.g., electrical hardware implemented by one or more transistors), or (ii) one or more general purpose semiconductor-based electrical circuits programmable with instructions to perform one or more specific functions(s) or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations or functions, Field Programmable Gate Arrays (FPGAs) that may be programmed with second instructions to at least one of configure or structure the FPGAs to instantiate one or more operations or functions corresponding to the first instructions, Graphics Processor Units (GPUs) that may execute first instructions to perform one or more operations or functions, Digital Signal Processors (DSPs) that may execute first instructions to perform one or more operations or functions, XPUs, Network Processing Units (NPUs) one or more microcontrollers that may execute first instructions to perform one or more operations or functions or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein, integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., at least one of programmed or hardwired) at a time of manufacturing by a manufacturer to at least one of perform the function or be configurable (or re-configurable) by a user after manufacturing to perform the function/or other additional or alternative functions. The configuring may be through at least one of firmware or software programming of the device, through at least one of a construction or layout of hardware components and interconnections of the device, or a combination thereof.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

In the description and claims, described “circuitry” may include one or more circuits. A circuit or device that is described herein as including certain components may instead be adapted to be coupled to those components to form the described circuitry or device. For example, a structure described as including one or more semiconductor elements (such as transistors), one or more passive elements (such as one of or a combination of resistors, capacitors, or inductors), or one or more sources (such as at least one of voltage sources or current sources) may instead include only the semiconductor elements within a single physical device (e.g., at least one of a semiconductor die or integrated circuit (IC) package) and may be adapted to be coupled to at least some of the passive elements or the sources to form the described structure either at a time of manufacture or after a time of manufacture, for example, by at least one of an end-user or a third-party.

Circuits described herein are reconfigurable to include the replaced components to provide functionality at least partially similar to functionality available prior to the component replacement. Components shown as resistors, unless otherwise stated, are generally representative of any one or more elements coupled in at least one of series or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other examples, additional or fewer features may be incorporated into the integrated circuit. In addition, some or all of the features illustrated as being external to the integrated circuit may be included in the integrated circuit and some features illustrated as being internal to the integrated circuit may be incorporated outside of the integrated. As used herein, the term “integrated circuit” means one or more circuits that are at least one of: (i) incorporated in/over a semiconductor substrate; (ii) incorporated in a single semiconductor package; (iii) incorporated into the same module; or (iv) incorporated in/on the same printed circuit board.

Uses of the phrase “ground” in the foregoing description include at least one of a chassis ground, an Earth ground, a floating ground, a virtual ground, a digital ground, a common ground, or any other form of ground connection applicable to, or suitable for, the teachings of this description. As used herein, “about” modifies its subject/value to recognize the potential presence of variations that occur in real world applications. For example, “about” may modify dimensions that may not be exact due to at least one of manufacturing tolerances or other real-world imperfections. Unless otherwise stated, “about” preceding a value means+/−10 percent of the stated value, or, if the value is zero, a reasonable range of values around zero.

From the foregoing, it will be appreciated that example systems, apparatus, articles of manufacture, and methods have been described that improve stability and reverse current protection in FVF configured LDO regulators. For example, described systems, apparatus, articles of manufacture, and methods include an open loop resistance control circuit that adjusts the resistance of a reverse current protection FET responsive to current flowing through a pass FET of an LDO regulator. As such, examples described herein do not implement closed loop control via a dedicated amplifier and, as such, consume significantly less area on a chip than an amplifier-based approach. For example, systems, apparatus, articles of manufacture, and methods described herein consume about 30,000 μm² less area than amplifier-based approaches.

Examples described herein increase the resistance of the reverse current protection FET without destabilizing control of the pass FET. For example, systems, apparatus, articles of manufacture, and methods described herein supply an amplifier driving the pass FET based on the input voltage to the LDO regulator and not the midpoint voltage between the pass FET and the reverse current protection FET. Thus, the voltage supplying the amplifier driving the pass FET is isolated from the varying resistance of the pass FET during operation. As such, the stability of control of the pass FET is independent on the on-resistance of an LDO regulator in examples described herein.

Described systems, apparatus, articles of manufacture, and methods improve the efficiency of using a computing device by reacting more quickly to reverse voltage conditions across a LDO regulator as compared to a low bandwidth amplifier-based approach. As such, devices upstream of the LDO regulator are protected from being damaged by reverse current through the LDO regulator. As described above, utilizing an open loop current mirror as described herein provides quicker response to reverse voltage conditions. Examples described herein also reduce the ratio between reverse current and maximum output current as compared to other approaches. For example, utilizing a sense FET with a small ratio of size to the pass FET and a scalable current mirror to drive the reverse current protection FET via a diode-connected transistor provides a reduced ratio between reverse current and maximum output current. Examples described herein also provide faster transient reverse current protection for a given quiescent current, lower maximum reverse current, and better load transient performance as compared to other approaches. Examples described herein also support a wider range of load capacitance and ESR as compared to other approaches. Described systems, apparatus, articles of manufacture, and methods are also directed to one or more improvement(s) in the operation of a machine such as a computer or other electronic, electromechanical, or mechanical device.

Modifications are possible in the described examples, and other examples are possible, within the scope of the claims.

What is claimed is:

1. An apparatus comprising:
a first transistor having a control terminal and first and second terminals;
a second transistor having a control terminal and first and second terminals, the second terminal of the second transistor coupled to the second terminal of the first transistor;
a first amplifier having a first input, a reference input, and an output, the first input of the first amplifier coupled to the first terminal of the first transistor, the output of the first amplifier coupled to the control terminal of the first transistor;
a second amplifier having first and second inputs and an output, the first input of the second amplifier coupled to the first terminal of the first transistor, the second input of the second amplifier coupled to the first terminal of the second transistor, and the output of the second amplifier coupled to the control terminal of the second transistor; and
a control circuit coupled to the control terminal and the second terminal of the second transistor and coupled to the first transistor, the control circuit capable of adjusting a voltage at the control terminal of the second transistor responsive to a current through the first transistor.

2. The apparatus of claim 1, wherein the control circuit includes:
a third transistor having a control terminal and first and second terminals, the control terminal of the third transistor coupled to the output of the first amplifier, the second terminal of the third transistor coupled to the second terminal of the first transistor;
a current mirror having an input and an output, the input of the current mirror coupled to the first terminal of the third transistor; and
a diode having first and second terminals, the first terminal of the diode coupled to the second terminal of the second transistor, the second terminal of the diode coupled to the output of the current mirror and the control terminal of the second transistor.

3. The apparatus of claim 2, wherein the diode is a fourth transistor having a control terminal and first and second terminals, the control terminal of the fourth transistor coupled to the first terminal of the fourth transistor, the output of the current mirror, and the control terminal of the second transistor, the second terminal of the fourth transistor coupled to the second terminal of the second transistor.

4. The apparatus of claim 2, wherein the third transistor is between 20 times and 1,000 times smaller than the first transistor.

5. The apparatus of claim 2, wherein the first amplifier has a supply terminal coupled to the second terminals of the first and second transistors.

6. The apparatus of claim 2, wherein the first amplifier has a supply terminal, and the apparatus includes a fourth transistor having a control terminal and first and second terminals, the control terminal of the fourth transistor coupled to the second terminal of the diode, the output of the current mirror, and the output of the second amplifier, the first terminal of the fourth transistor coupled to the first terminal of the second transistor, and the second terminal of the fourth transistor coupled to the supply terminal of the first amplifier.

7. The apparatus of claim 1, wherein the first amplifier has a supply terminal coupled to the second terminals of the first and second transistors.

8. The apparatus of claim 1, wherein the first amplifier has a supply terminal, and the apparatus includes a third transistor having a control terminal and first and second terminals, the control terminal of the third transistor coupled to the control circuit and the output of the second amplifier, the first terminal of the third transistor coupled to the first terminal of the second transistor, and the second terminal of the third transistor coupled to the supply terminal of the first amplifier.

9. The apparatus of claim 8, wherein the third transistor is between 20 times and 1,000 times smaller than the second transistor.

10. An apparatus comprising:
a first transistor having a control terminal and first and second terminals;
a second transistor having a control terminal and first and second terminals, the second terminal of the second transistor coupled to the second terminal of the first transistor;
a first amplifier having a supply terminal, a first input, a reference input, and an output, the first input of the first amplifier coupled to the first terminal of the first transistor, the output of the first amplifier coupled to the control terminal of the first transistor;
a second amplifier having first and second inputs and an output, the first input of the second amplifier coupled to the first terminal of the first transistor, the second input of the second amplifier coupled to the first terminal of the second transistor, and the output of the second amplifier coupled to the control terminal of the second transistor; and
a third transistor having a control terminal and first and second terminals, the first terminal of the third transistor coupled to the first terminal of the second transistor, the second terminal of the third transistor coupled to the supply terminal of the first amplifier, and the control terminal of the third transistor coupled to the output of the second amplifier.

11. The apparatus of claim 10, further comprising a control circuit coupled to the control terminal of the second transistor and coupled to the first transistor, the control circuit capable of adjusting a voltage at the control terminal of the second transistor based on a current through the first transistor.

12. The apparatus of claim 10, further comprising:
a fourth transistor having a control terminal and first and second terminals, the control terminal of the third transistor coupled to the output of the first amplifier, the second terminal of the fourth transistor coupled to the second terminals of the first and second transistors;
a fifth transistor having a control terminal and first and second terminals, the control terminal of the fifth transistor coupled to the first terminal of the fourth transistor and the first terminal of the fifth transistor;
a sixth transistor having a control terminal and first and second terminals, the control terminal of the sixth transistor coupled to the control terminal of the fifth transistor, the first terminal of the sixth transistor coupled to the control terminal of the second transistor and the control terminal of the third transistor, the second terminal of the sixth transistor coupled to the second terminal of the fifth transistor; and
a seventh transistor having a control terminal and first and second terminals, the control terminal of the seventh transistor coupled to the first terminal of the seventh transistor, the first terminal of the sixth transistor, the control terminal of the third transistor, and the control terminal of the second transistor, the second terminal of the seventh transistor coupled to the second terminals of the first and second transistors.

13. The apparatus of claim 12, wherein the fourth transistor is between 20 times and 1,000 times smaller than the first transistor.

14. The apparatus of claim 10, wherein the third transistor is between 20 times and 1,000 times smaller than the second transistor.

15. A system comprising:
a low-dropout (LDO) regulator having an input voltage terminal, a reference terminal, and an output voltage terminal, the LDO regulator including:
a first transistor having a control terminal and first and second terminals;
a second transistor having a control terminal and first and second terminals, the second terminal of the second transistor coupled to the second terminal of the first transistor;
a first amplifier having a supply terminal, a first input, a reference input, and an output, the first input of the first amplifier coupled to the first terminal of the first transistor, the output of the first amplifier coupled to the control terminal of the first transistor;
a second amplifier having first and second inputs and an output, the first input of the second amplifier coupled to the first terminal of the first transistor, the second input of the second amplifier coupled to the first terminal of the second transistor, the output of the second amplifier coupled to the control terminal of the second transistor;
a supply circuit coupled to the supply terminal of the first amplifier; and
a control circuit coupled to the control terminal of the second transistor and coupled to the first transistor, the control circuit capable of adjusting a voltage at the control terminal of the second transistor based on a current through the first transistor.

16. The system of claim 15, wherein the control circuit includes:
a third transistor having a control terminal and first and second terminals, the control terminal of the third transistor coupled to the output of the first amplifier, the second terminal of the third transistor coupled to the second terminal of the first transistor;
a current mirror having an input and an output, the input of the current mirror coupled to the first terminal of the third transistor; and
a diode having first and second terminals, the first terminal of the diode coupled to the second terminal of the second transistor, the second terminal of the diode coupled to the output of the current mirror and the control terminal of the second transistor.

17. The system of claim 16, wherein the third transistor is between 20 times and 1,000 times smaller than the first transistor.

18. The system of claim 16, wherein the supply circuit includes a fourth transistor having a control terminal and first and second terminals, the control terminal of the fourth transistor coupled to the output of the second amplifier and the second terminal of the diode, the first terminal of the fourth transistor coupled to the first terminal of the second transistor, the second terminal of the fourth transistor coupled to the supply terminal of the first amplifier.

19. The system of claim 18, wherein the fourth transistor is between 20 times and 1,000 times smaller than the second transistor.

20. The system of claim 15, further comprising:
a voltage source having a terminal coupled to the input voltage terminal of the LDO regulator; and
a load having a terminal coupled to the output voltage terminal of the LDO regulator.
